(19) United States
(12) Patent Application Publication
(10) Pub. No.: US 2020/0273685 A1
(43) Pub. Date: Aug. 27, 2020

(54) ION SOURCE FOR GENERATING IONS AND CALIBRATING METHODS OF MASS SPECTROMETER USING GENERATED IONS

(71) Applicant: SHIMADZU CORPORATION, Kyoto (JP)

(72) Inventors: Liang WANG, Shanghai (CN); Wenjian SUN, Shanghai (CN); Xiaoqiang ZHANG, Shanghai (CN)

(21) Appl. No.: 16/684,752

(22) Filed: Nov. 15, 2019

(30) Foreign Application Priority Data
Feb. 26, 2019 (CN) 201910140722.X

(51) Int. Cl. H01J 49/00; H01J 49/12

(52) U.S. Cl. CPC H01J 49/0009; H01J 49/12

(57) ABSTRACT

The invention relates to an ion source for generating ions for calibrating a mass spectrometer and methods for calibrating the mass spectrometer using the generated ions. The ion source includes a container used for containing a sample; an ionization device used for ionizing a sample by plasma discharge to generate ions for calibrating the mass spectrometer, where the ionization device operates at atmospheric pressure; and a delivery device for delivering the sample from the container to the ionization device. The method includes generating ions by plasma discharge at atmospheric pressure using a sample; inputting at least one part of the ions into the mass spectrometer to obtain a mass spectrogram; and calibrating the mass spectrometer according to the mass spectrogram.

### CROSS-REFERENCE TO RELATED APPLICATION

This application claims priority to and the benefit of Chinese Patent Application No. 201910140722.X, filed Feb. 26, 2019 in the State Intellectual Property Office of P.R. China, which is hereby incorporated herein in its entirety by reference.

### FIELD OF THE INVENTION

The present invention relates generally to a mass spectrometer and an ion source used therefor, and more particularly to methods for calibrating a mass spectrometer and an ion source for generating ions used for calibrating the mass spectrometer.

### BACKGROUND OF THE INVENTION

Mass spectrometers have been widely used in various fields, such as biology, medical hygiene, food chemistry, and petrochemical industry, in recent years. By deflecting charged particles in an electromagnetic field, a mass spectrometer is capable of separating atoms, molecules or molecular fragments according to differences in mass-to-charge ratios of them, thereby detecting the substance composition.

### SUMMARY OF THE INVENTION

According to one aspect of the invention, an ion source for generating ions used for calibrating a mass spectrometer is provided. The ion source comprises a container used for containing a sample; an ionization device used for ionizing the sample by plasma discharge to generate ions used for calibrating the mass spectrometer, wherein the ionization device operates at atmospheric pressure; and a delivery device used for delivering the sample from the container to the ionization device.

According to another aspect of the invention, a mass spectrometer is provided, comprising the ion source described above.

According to yet another aspect of the invention, a method for calibrating the mass spectrometer is provided, comprising: generating ions by plasma discharge at atmospheric pressure using a sample; inputting at least one part of the ions into the mass spectrometer to obtain a mass spectrogram; and calibrating the mass spectrometer according to the mass spectrogram.

According to yet another aspect of the invention, a method for calibrating the mass spectrometer is provided, comprising: generating first ions by plasma discharge at atmospheric pressure using polydimethylsiloxane; inputting at least one part of positive ions in the first ions into the mass spectrometer to obtain a first mass spectrogram; calibrating the mass spectrometer according to the first mass spectrogram; generating second ions by plasma discharge at atmospheric pressure using perfluoropolyether; inputting at least one part of negative ions in the second ions into the mass spectrometer to obtain a second mass spectrogram; and calibrating the mass spectrometer according to the second mass spectrogram.

According to yet another aspect of the invention, a siloxane polymer is provided as a calibration substance for the mass spectrometer.

These and other aspects of the invention will become apparent from the following description of the preferred embodiment taken in conjunction with the following drawings, although variations and modifications therein may be affected without departing from the spirit and scope of the novel concepts of the invention.

### BRIEF DESCRIPTION OF THE DRAWINGS

The following drawings form part of the present specification and are included to further demonstrate certain aspects of the invention. The invention may be better understood by reference to one or more of these drawings in combination with the detailed description of specific embodiments presented herein. The drawings described below are for illustration purposes only. The drawings are not intended to limit the scope of the present teachings in any way.

FIG. 1 shows a schematic diagram of an ion source for generating ions used for calibrating a mass spectrometer according to one embodiment of the invention.

FIG. 2 shows a flow chart of a method for calibrating the mass spectrometer using the ion source described above according to one embodiment of the invention.

FIG. 3 shows a mass spectrogram according to one embodiment of the invention.

FIG. 4 shows a mass spectrogram according to one embodiment of the invention.

FIG. 5 shows a mass spectrogram according to one embodiment of the invention.

FIG. 6 shows a mass spectrogram according to one embodiment of the invention.

FIG. 7 shows a mass spectrogram according to one embodiment of the invention.

FIG. 8 shows a mass spectrogram according to one embodiment of the invention.

FIG. 9 shows a mass spectrogram according to one embodiment of the invention.

FIG. 10 shows a schematic diagram of the ion source used for the mass spectrometer according to one embodiment of the invention.

FIG. 11 shows a schematic diagram of the ion source used for the mass spectrometer according to one embodiment of the invention.

FIG. 12 shows a cross-sectional view of a sampling interface of the mass spectrometer according to one embodiment of the invention.

FIG. 13 shows a schematic diagram of the ion source for generating the ions used for calibrating the mass spectrometer according to one embodiment of the invention.

### DETAILED DESCRIPTION OF THE INVENTION

The present invention will now be described more fully hereinafter with reference to the accompanying drawings, in which exemplary embodiments of the present invention are shown. The present invention may, however, be embodied in many different forms and should not be construed as limited to the embodiments set forth herein. Rather, these embodiments are provided so that this description will be thorough and complete, and will fully convey the scope of the invention to those skilled in the art.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting and/or capital letters has no influence on the scope and meaning of a term; the scope and meaning of a term are the same, in the same context, whether or not it is highlighted and/or in capital letters. It will be appreciated that the same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only and in no way limits the scope and meaning of the invention or of any exemplified term. Likewise, the invention is not limited to various embodiments given in this specification.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below can be termed a second element, component, region, layer or section without departing from the teachings of the present invention.

It will be understood that, as used in the description herein and throughout the claims that follow, the meaning of “a”, “an”, and “the” includes plural reference unless the context clearly dictates otherwise. Also, it will be understood that when an element is referred to as being “on,” “attached” to, “connected” to, “coupled” with, “contacting,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” to another feature may have portions that overlap or underlie the adjacent feature.

It will be further understood that the terms “comprises” and/or “comprising,” or “includes” and/or “including” or “has” and/or “having” when used in this specification specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the figures. It will be understood that relative terms are intended to encompass different orientations of the device in addition to the orientation shown in the figures. For example, if the device in one of the figures is turned over, elements described as being on the “lower” side of other elements would then be oriented on the “upper” sides of the other elements. The exemplary term “lower” can, therefore, encompass both an orientation of lower and upper, depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and the invention, and will not be interpreted in an idealized or overly formal sense unless expressly so defined herein.

As used in this specification, “around”, “about”, “approximately” or “substantially” shall generally mean within 20 percent, preferably within 10 percent, and more preferably within 5 percent of a given value or range. Numerical quantities given herein are approximate, meaning that the term “around”, “about”, “approximately” or “substantially” can be inferred if not expressly stated.

As used in this specification, the phrase “at least one of A, B, and C” should be construed to mean a logical (A or B or C), using a non-exclusive logical OR. As used herein, the term “and/or” includes any and all combinations of one or more of the associated listed items.

The description below is merely illustrative in nature and is in no way intended to limit the invention, its application, or uses. The broad teachings of the invention can be implemented in a variety of forms. Therefore, while this invention includes particular examples, the true scope of the invention should not be so limited since other modifications will become apparent upon a study of the drawings, the specification, and the following claims. For purposes of clarity, the same reference numbers will be used in the drawings to identify similar elements. It should be understood that one or more steps within a method may be executed in different order (or concurrently) without altering the principles of the invention.

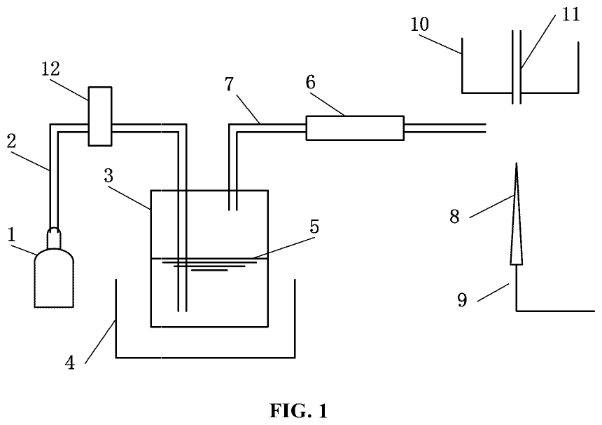

FIG. 1 shows a schematic diagram of an ion source for generating ions used for calibrating a mass spectrometer according to one embodiment of the invention.

In this exemplary embodiment shown in FIG. 1, the ion source comprises a gas source 1, a first gas delivery pipe 2, a container 3, a second gas delivery pipe 7, and a discharge needle 8. The gas source 1 can provide a carrier gas such as a nitrogen gas, air or an inert gas. The carrier gas from the gas source 1 can enter the container 3 through the first gas delivery pipe 2. The container 3 has a sample material for generating ions therein. One end of the second gas delivery pipe 7 is positioned inside the container 3, and the other end is positioned near the tip end of the discharge needle 8. The vapor of the sample material in the container 3 can enter the second gas delivery pipe 7 along with the carrier gas and be transmitted to the vicinity of the tip end of the discharge needle 8.

As shown in FIG. 1, when the sample material is a liquid, the tail end of the first gas delivery pipe 2 can extend below a liquid level 5, so that more sample materials enter the second gas delivery pipe 7 along with the carrier gas. In one embodiment, the tail end of the first gas delivery pipe 2 can also be positioned above the liquid level 5, and some sample materials can also be delivered to the vicinity of the tip end of the discharge needle 8 through the second gas delivery pipe 7 along with the carrier gas.

In this example shown in FIG. 1, the gas source 1, the first gas delivery pipe 2, and the second gas delivery pipe 7 collectively constitute one example of the delivery device according to the invention.

Further, the discharge needle 8 is one example of an ionization device according to the invention. The discharge needle 8 can be connected to a power source (not shown) by, for example, a wire 9. A voltage applied to the discharge needle 8 is utilized to generate discharge, such as corona discharge, at the tip end of the discharge needle 8. Under the action of discharge, sample molecules near the tip end of the discharge needle 8 are ionized to generate various ions (e.g., fragment ions and/or molecular ions), and at least one part of these fragment ions can be input into a mass spectrometer 10 through a sampling interface 11 of the mass spectrometer 10 and measured to obtain a mass spectrogram. The mass spectrogram obtained by measuring can be used for calibrating the mass spectrometer. For example, the measured mass spectrogram can be compared with a known mass spectrogram, for example, stored in a database, and the voltage and/or mass axis of the mass spectrometer is adjusted, so that the mass spectrum peaks in the measured mass spectrogram are consistent with the mass spectral peaks of the known mass spectrogram, thereby achieving the calibration of the mass spectrometer.

As shown in FIG. 1, in one embodiment, the ion source can also comprise a valve 12. The valve 12 can be arranged on the first gas delivery pipe 2 (as shown in FIG. 1) or can be arranged on the second gas delivery pipe 7. The valve 12 can control the first gas delivery pipe 2 or the second gas delivery pipe 7 to be turned on and off. In another optional example, the valve can be arranged on both the first gas delivery pipe 2 and the second gas delivery pipe 7 according to actual needs.

In addition, as shown in FIG. 1, in one embodiment, the ion source also comprises a first heater 4 used for heating the sample material in the container 3. For example, in one embodiment, the first heater 4 can be a water bath device so that the sample material in the container 3 is maintained at a predetermined temperature. In another embodiment, the first heater 4 can be, for example, an electric heating coil or electric heating film arranged on the container 3, and the invention does not limit the kind of the first heater 4 as long as the container 3 can be heated. The first heater 4 is utilized to allow more sample materials to enter the second gas delivery pipe 7 along with the carrier gas.

Furthermore, as shown in FIG. 1, in one embodiment, a second heater 6 can be also arranged on the second gas delivery pipe 7 and used for heating the second gas delivery pipe 7. The second heater 6 can be, for example, a ceramic heating bushing, and an electric heating film arranged on the second gas delivery pipe 7. By the second heater 6, the temperature of the gas delivered in the second gas delivery pipe 7 can be increased to reduce or avoid the condensation of the vapor of the sample material in the second gas delivery pipe 7, otherwise, the clogging of the second gas delivery pipe 7 may be caused.

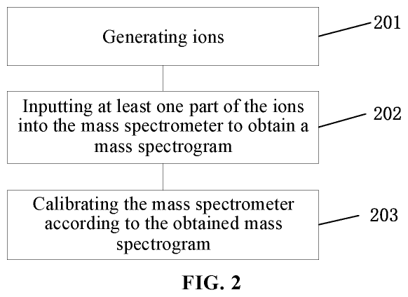

FIG. 2 shows a flow chart of a method for calibrating the mass spectrometer using the ion source described above according to one embodiment of the invention. As shown in FIG. 2, the method comprises the following steps. At step 201, ions are generated using an ion source according to the invention. At step 202, at least one part of the ions is input into the mass spectrometer to obtain a mass spectrogram. At step 203, the mass spectrometer is calibrated according to the obtained mass spectrogram.

Each step in the above method will be described and explained in detail below in conjunction with specific embodiments.

In one embodiment according to the invention, dimethylsilicone oil is used as the sample material for generating ions. The dimethylsilicone oil is also known as polydimethylsiloxane, and the molecular formula thereof is [—O(CH₃)₂Si—]ₙ. The structural formula is as follows:

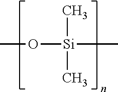

In some embodiments of the invention, the degree of polymerization n of the above dimethylsilicone oil can range, for example, from about 2 to about 2000. In some embodiments of the invention, the degree of polymerization n of the dimethylsilicone oil can range, for example, from about 2 to about 1000. In some embodiments of the invention, the dimethylsilicone oil has an average molecular weight of about 500 to about 100000.

In one embodiment according to the invention, the dimethylsilicone oil is placed in the container 3 of the ion source shown in FIG. 1 to be used as the sample material, and the nitrogen gas is used as the carrier gas. The nitrogen gas from the gas source 1 enters below the liquid level 5 of the dimethylsilicone oil in the container 3 via the first gas delivery pipe 2 at a flow rate of about 0.1 L/min. The vapor of the dimethylsilicone oil in the container 3 enters the second gas delivery pipe 7 along with the carrier gas. The second gas delivery pipe 7 delivers the vapor of the dimethylsilicone oil and the nitrogen gas to the vicinity of the tip of the discharge needle 8.

It should be understood that the flow rate of the above carrier gas is only one example. In the embodiment according to the invention, the flow rate of the carrier gas is generally controlled in a range of about 0.02 to about 2 L/min. In some optional examples, the flow rate of the carrier gas can be controlled in a range of about 0.1 to about 0.5 L/min.

Further, in some embodiments, the distance between the tail end of the second gas delivery tube 7 and the tip end of the discharge needle 8 can be maintained between about 5 mm and about 50 mm. In some embodiments, the tail end of the second gas delivery tube 7 is at a distance of less than about 10 mm from the tip end of the discharge needle 8.

The operating mode of the ion source can be divided into a positive ion mode and a negative ion mode according to different voltages applied to the discharge needle 8. In the positive ion mode, a positive voltage is applied to the discharge needle 8; in the negative ion mode, a negative voltage is applied to the discharge needle 8.

In the ion source according to the invention, the voltage that can be applied to the discharge needle 8 ranges from about 3 kV to about 10 kV. In some embodiments, the voltage ranges from about 3.5 kV to about 4.5 kV. For example, in one embodiment, the positive voltage of about 4 kV is applied to the discharge needle 8 via the wire 9 (i.e., the ion source operates in the positive ion mode) to generate corona discharge at the tip end of the discharge needle 8. Under the action of corona discharge, dimethylsilicone oil molecules near the discharge needle 8 can be ionized into various fragment ions. Under the action of the electric field of the discharge needle 8, the negatively charged fragment ions move toward the discharge needle 8, and the positively charged fragment ions are driven into the sampling interface 11 of the mass spectrometer 10.

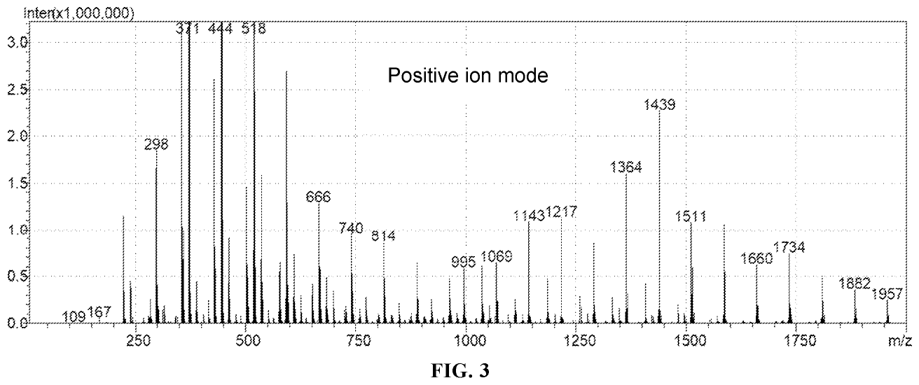

The mass spectrometer 10 can measure the mass spectrogram of the fragment ions, and the obtained mass spectrogram is shown in FIG. 3. In the mass spectrogram shown in FIG. 3, the horizontal axis represents a mass-to-charge ratio (m/z), and the vertical axis represents the intensity of the mass spectrum peaks. It can be seen from FIG. 3 that in the positive ion mode, evenly spaced mass spectrum peaks can be obtained by the fragment ions of the dimethylsilicone oil, and the mass-to-charge ratio range that can be covered by the mass spectrum peaks is from about 50 to about 2000, and the mass spectrometer can be calibrated in the range.

The calibration process of the mass spectrometer is briefly described below by taking the mass spectrogram shown in FIG. 3 as an example.

In the ionization process of dimethylsilicone oil, various ion fragments may be generated. For the calibration of the mass spectrometer, it is not necessary to identify which fragment ions correspond to the respective mass spectrum peaks in the mass spectrogram respectively.

It can be seen from the structural formula of the above dimethylsilicone oil that when being ionized into fragment ions at the discharge needle 8, it is possible to generate two fragment ions (m≥1) having degrees of polymerization of m and m+1, and the difference in molecular weight between the two fragment ions is about 74 (i.e., the molecular weight of one basic unit). Therefore, peaks with a difference in mass-to-charge ratio of about 74 can be found in the mass spectrogram and used as characteristic peaks. The calibration of the mass spectrometer can be achieved by adjusting the voltage and/or mass axis of the mass spectrometer to align these characteristic peaks with known characteristic peaks in the database.

For example, in the mass spectrogram of FIG. 3, the difference in mass-to-charge ratio between the peak having the mass-to-charge ratio of 371 and the peak having the mass-to-charge ratio of 444 is about 73 (approximately equal to 74), the difference in mass-to-charge ratio between the peak having the mass-to-charge ratio of 444 and the peak having the mass-to-charge ratio of 518 is about 74, the difference in mass-to-charge ratio between the peak having the mass-to-charge ratio of 740 and the peak having the mass-to-charge ratio of 814 is about 74, the difference in mass-to-charge ratio between the peak having the mass-to-charge ratio of 1143 and the peak having the mass-to-charge ratio of 1217 is about 74, the difference in mass-to-charge ratio between the peak having the mass-to-charge ratio of 1364 and the peak having the mass-to-charge ratio of 1439 is about 75 (approximately equal to 74), the difference in mass-to-charge ratio between the peak having the mass-to-charge ratio of 1660 and the peak having the mass-to-charge ratio of 1734 is about 74, and the difference in mass-to-charge ratio between the peak having the mass-to-charge ratio of 1882 and the peak having the mass-to-charge ratio of 1957 is about 75 (approximately equal to 74), therefore, these paired characteristic peaks can be used to calibrate the mass spectrometer. In general, multiple paired characteristic peaks can be selected from the mass spectrogram for calibration. In some embodiments, these characteristic peaks may cover the measurement range (e.g., about 50 to about 2000) of the mass spectrometer. For example, in one example, peaks having the following mass-to-charge ratios can be selected for calibration: 371 and 444, 1143 and 1217, and 1882 and 1957. Of course, those skilled in the art will appreciate that more paired peaks can be selected from the mass spectrogram, for example, one or more pairs of 444 and 518, 740 and 814, 1364 and 1439, 1660 and 1734. The specific adjustment and operation of the mass spectrometer are well known to those skilled in the art and will not be described in detail in the invention.

Further, as described above, the ion source according to the invention can comprise the first heater 4. In some embodiments, the container 3 can also be heated by the first heater 4, so that the temperature of the dimethylsilicone oil in the container 3 is maintained, for example, between about 10° C. and about 200° C. (e.g., about 80° C.). In this way, more vapor of the dimethylsilicone oil can enter the second gas delivery pipe 7 along with the carrier gas.

In addition, as described above, the ion source according to the embodiment of the invention can comprise the second heater 6. In one embodiment according to the invention, the second gas delivery pipe 7 can be heated using the second heater 6. For example, the second heater 6 can be a ceramic heating bushing, and the heating temperature is between about 100° C. and about 300° C. In the specific example in which the mass spectrogram of FIG. 3 described above is obtained, the temperature of the second heater 6 is about 200° C. By the second heater 6, the vapor of the dimethylsilicone oil can be prevented from being condensed in the second gas delivery pipe 7, thereby avoiding clogging of the second gas delivery pipe 7.

Moreover, in one embodiment, the sampling interface 11 of the mass spectrometer 10 can be a capillary tube and can be heated to about 200° C. to about 500° C. In some embodiments, the temperature of the sampling interface 11 is controlled between about 200° C. and about 300° C. In the specific example in which the mass spectrogram of FIG. 3 described above is formed, the temperature of the sampling interface 11 is about 250° C. The sampling interface 11 may be desolvated by heating and the ion through rate can be ensured.

As described above, when the ion source operates in the positive ion mode, the positively charged fragment ions enter the mass spectrometer, and the mass spectrometer is calibrated according to the mass spectrogram of the positive ions. In some cases, the ions to be measured by the mass spectrometer may be negative ions. At this time, the ion source can operate in the negative ion mode, so that the negatively charged fragment ions enter the mass spectrometer, and the mass spectrometer is calibrated according to the mass spectrogram of the negative ions.

In certain embodiments, both positive and negative ions are measured by the mass spectrometer. According to some embodiments of the invention, the mass spectrometer can be calibrated multiple times. For example, after the mass spectrometer is calibrated according to the mass spectrogram shown in FIG. 3, the ion source can also operate in the negative ion mode to obtain a new mass spectrogram, and then the mass spectrometer is calibrated again according to the new mass spectrogram.

In the negative ion mode, the negative voltage, for example, about −4 kV, is applied to the discharge needle 8. Thus, under the action of corona discharge, the dimethylsilicone oil is ionized to generate various fragment ions. Wherein, the negatively charged fragment ions are driven by the electric field to enter the sampling interface 11 of the mass spectrometer 10. In this way, the mass spectrometer 10 can obtain a new mass spectrogram.

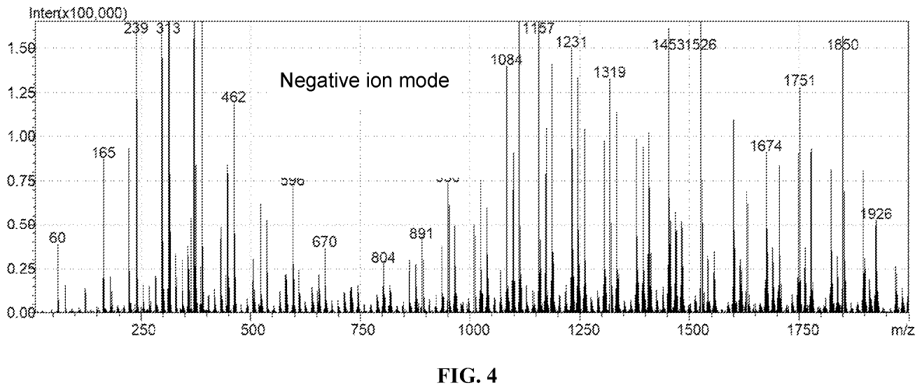

FIG. 4 shows a mass spectrogram obtained when the ion source operates in a negative ion mode. As shown in FIG. 4, in the mass spectrogram obtained in the negative ion mode, the mass-to-charge ratio range covered by the mass spectrum peaks is from about 50 to about 2000, and the mass spectrum peaks are evenly spaced, and are evenly distributed in the mass-to-charge ratio range of about 50 to about 2000. Therefore, the mass spectrogram suitable for calibrating the mass spectrometer can also be obtained in the negative ion mode using the dimethylsilicone oil.

In certain embodiments, the method/process for calibrating the mass spectrometer according to the mass spectrogram has been described above and will not be repeated herein.

In certain embodiments, as described above, the dimethylsilicone oil is a material that is very suitable for calibrating the mass spectrometer.

In the existing art, the mass spectrometer is generally calibrated using lock mass sample ions. For example, the lock mass sample ions are introduced downstream of the ion source, and the lock mass sample ions and analysis sample ions are mixed and then introduced into the mass analysis of the subsequent stage. Wherein, the lock mass sample ions are generated in a low pressure region (i.e., positioned in a vacuum chamber). Therefore, there are specific requirements for the design of an ion optical system of an instrument and an electrode structure.

It has been desirable to design an ionization source which is simple in structure and can operate at atmospheric pressure to calibrate the mass spectrometer. However, a suitable substance has not been found as a sample material, and the inventors of the invention have unexpectedly found that the dimethylsilicone oil is particularly suitable for use as the sample material for calibrating the mass spectrometer. Based on this finding, the ion source described above according to the embodiment of the invention is designed and manufactured.

It should be understood that the term “at atmospheric pressure” in the invention means in air, rather than in an environment such as a vacuum. The term not only comprises the definition of air pressure, but also comprises the definition of the atmosphere. That is, it is not only that the air pressure is basically the atmospheric pressure, but also that it is roughly in an air atmosphere.

By utilizing the dimethylsilicone oil and the ion source according to the above embodiments of the invention, the fragment ions can be directly generated at atmospheric pressure without requiring a low pressure region or a vacuum environment. Therefore, the sampling interface of the mass spectrometer is modified to a small extent and is suitable for many existing mass spectrometers.

The ion source according to the above embodiments of the invention can be specifically used for calibrating the mass spectrometer, thereby avoiding switching of a calibration sample and an analysis sample, and simplifying the experimental operation.

The ion source is simple in structure, low in cost, and easy to maintain. Further, there is no specific requirement or limitation on the structure, shape, and orientation of the sampling interface of the mass spectrometer as long as the sampling interface is positioned near the tip of the discharge needle 8. For example, in some embodiments, the sampling interface of the mass spectrometer is at a distance of about 5 mm to about 30 mm from the tip end of the discharge needle 8. In some embodiments, the sampling interface of the mass spectrometer is at a distance of about 5 mm to about 10 mm from the tip end of the discharge needle 8.

By utilizing the dimethylsilicone oil, the high quality mass spectrograms can be obtained in both positive ion mode and negative ion mode. Referring to the mass spectrograms of FIGS. 3 and 4, in the mass spectrograms obtained in the positive ion mode and negative ion mode, the mass spectrum peaks can cover the mass-to-charge ratio range of about 50 to about 2000, and the mass spectrum peaks are evenly spaced and well distributed in the mass-to-charge ratio range. Therefore, the calibration within the mass-to-charge ratio of 2000 can be achieved. The inventors of the invention have attempted to calibrate the mass spectrometer using a variety of other materials, but most materials are not suitable. The mass spectrum peaks of these materials tend to be distributed within a relatively small mass-to-charge ratio range, or are not evenly spaced, and it is difficult to find a suitable characteristic peak.

By using the dimethylsilicone oil as the calibration sample, the calibration of the mass spectrometer and sample analysis are independent of each other without interference. Specifically, by using the dimethylsilicone oil as the calibration sample, only when the voltage is applied to the discharge needle 8 and the corona discharge is performed, the corresponding fragment ions enter the mass spectrometer. After the voltage on the discharge needle 8 is removed, no fragment ions are generated and no interference with the subsequent sample analysis is generated.

Optionally, the ion source according to the embodiment of the invention can be removable. That is, when the mass spectrometer is calibrated, the ion source is moved to the vicinity of the sampling interface of the mass spectrometer. After the calibration of the mass spectrometer is completed, the ion source is moved to a position away from the sampling interface of the mass spectrometer. Therefore, the ion source can be a separate device independent of the mass spectrometer.

Optionally, the ion source according to the embodiment of the invention can be integrated into the mass spectrometer as part of the mass spectrometer. As described above, since the dimethylsilicone oil is used as the calibration sample, and the dimethylsilicone oil does not interfere with the subsequent sample analysis, the ion source may also be fixed.

The inventors of the invention have further studied other materials on the basis of the use of dimethylsilicone oil in the calibration of mass spectrometers. The dimethylsilicone oil, also known as polydimethylsiloxane, is a siloxane polymer. The inventors of the invention have further discovered that all the siloxane polymers are relatively suitable for use as calibration samples for the mass spectrometers.

For example, poly(methyl-3,3,3-trifluoropropylsiloxane) is a siloxane polymer, and the substance can also be used for calibrating the mass spectrometer. The molecular formula thereof is —(C₄H₄F₃OSi)—, and the structural formula is as follows:

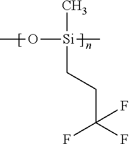

By utilizing the ion source shown in FIG. 1, the poly (methyl-3,3,3-trifluoropropylsiloxane) can also obtain mass spectrograms suitable for calibrating the mass spectrometer in both negative ion mode and positive ion mode. In one specific example, the carrier gas is the nitrogen gas, the flow rate is controlled at about 0.5 L/min, the temperature of the first heater 4 is controlled between about 10° C. and about 200° C. (about 50° C. in the embodiment), the temperature of the second heater 6 is controlled at about 200° C., and the absolute value of the voltage of the discharge needle 8 is about 4 kV. The temperature of the sampling interface 11 of the mass spectrometer 10 is about 250° C.

In certain embodiments of the invention, the poly(methyl-3,3,3-trifluoropropylsiloxane) has the degree of polymerization of about 2 to about 100000. In other embodiments of the invention, the poly(methyl-3,3,3-trifluoropropylsiloxane) has the degree of polymerization of about 2 to about 1000. In other embodiments of the invention, the poly(methyl-3,3,3-trifluoropropylsiloxane) has the average molecular weight of about 1000 to about 8000, for example, the average molecular weight can be about 2400 and about 4500.

The specific operation steps are similar to those of the above dimethylsilicone oil, and will not be repeated herein.

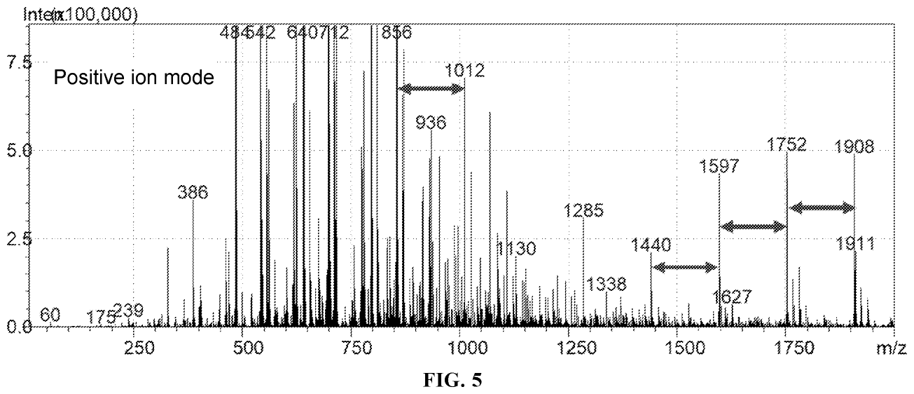

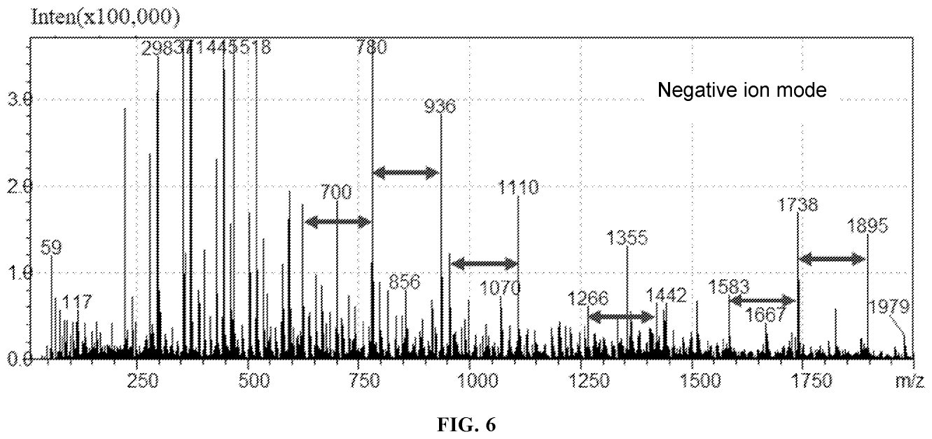

FIG. 5 shows a mass spectrogram obtained by poly(methyl-3,3,3-trifluoropropylmethylsiloxane) having an average molecular weight of 2400 in a positive ion mode. FIG. 6 shows a mass spectrogram obtained by poly(methyl-3,3,3-trifluoropropylmethylsiloxane) having the average molecular weight of 2400 in the negative ion mode.

As shown in FIG. 5, in the positive ion mode, the evenly spaced mass spectrogram can be obtained by utilizing the fragment ions of poly(methyl-3,3,3-trifluoropropylmethylsiloxane). A basic unit of poly(methyl-3,3,3-trifluoropropylmethylsiloxane) has a molecular weight of about 156 or 157. Therefore, the mass spectrum peaks with a mass-to-charge ratio (m/z) spacing of about 156 or 157 in the mass spectrogram can be used for calibrating the mass spectrometer, for example, (856, 1012), (1440, 1597), (1597, 1752), and (1752, 1908). The spacing between these paired mass spectrum peaks is about 156 or 157 and can therefore be used for calibrating the mass spectrometer.

Similarly, as shown in FIG. 6, in the negative ion mode, the evenly spaced mass spectrogram can be obtained by utilizing the fragment ions of poly(methyl-3,3,3-trifluoropropylmethylsiloxane). The basic unit of poly(methyl-3,3,3-trifluoropropylmethylsiloxane) has the molecular weight of about 156 or 157. Therefore, the mass spectrum peaks with the mass-to-charge ratio (m/z) spacing of about 156 or 157 in the mass spectrogram can be used for calibrating, for example, (780, 936), (1583, 1738), and (1738, 1895). The spacing between these paired mass spectrum peaks is about 156 or 157 and can therefore be used for calibrating the mass spectrometer.

As can be seen from the mass spectrograms of FIGS. 5 and 6, the mass spectrograms generated by poly(methyl-3,3,3-trifluoropropylmethylsiloxane) in both positive ion mode and negative ion mode can be used for calibrating the mass spectrometers. Therefore, the mass spectrometer can be calibrated in both positive ion mode and negative ion mode, respectively, by using a substance, poly(methyl-3,3,3-trifluoropropylmethylsiloxane).

In another embodiment according to the invention, another siloxane polymer, i.e., polydimethylsiloxane, trimethylsiloxy terminated, also known as trimethylsiloxy-terminated polydimethylsiloxane. The structural formula thereof is as follows:

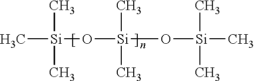

By utilizing the ion source shown in FIG. 1, the trimethylsiloxy-terminated polydimethylsiloxane can also obtain mass spectrograms suitable for calibrating the mass spectrometer in both negative ion mode and positive ion mode. In one specific example, the carrier gas is the nitrogen gas, the flow rate is controlled at about 0.5 L/min, the temperature of the first heater 4 is controlled at about 150° C., the temperature of the second heater 6 is controlled at about 200° C., and the absolute value of the voltage of the discharge needle 8 is about 4 kV. The temperature of the sampling interface 11 of the mass spectrometer 10 is about 250° C.

In some embodiments of the invention, the trimethylsiloxy-terminated polydimethylsiloxane has the degree of polymerization of about 2 to about 100000. In other embodiments of the invention, the trimethylsiloxy-terminated poly(methyl-3,3,3-trifluoropropylmethylsiloxane) has the degree of polymerization of about 2 to about 1000. In other embodiments of the invention, the trimethylsiloxy-terminated polydimethylsiloxane has the average molecular weight of about 800 to about 5000.

The specific operation steps are similar to those of the above dimethylsilicone oil, and will not be repeated herein.

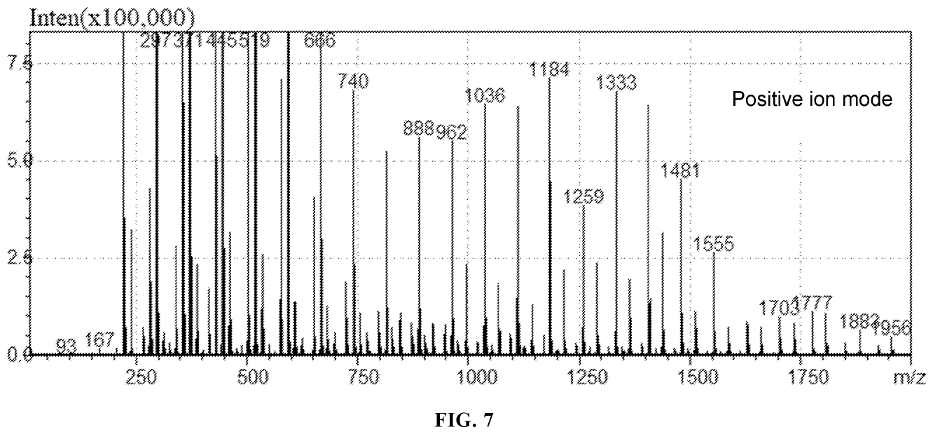

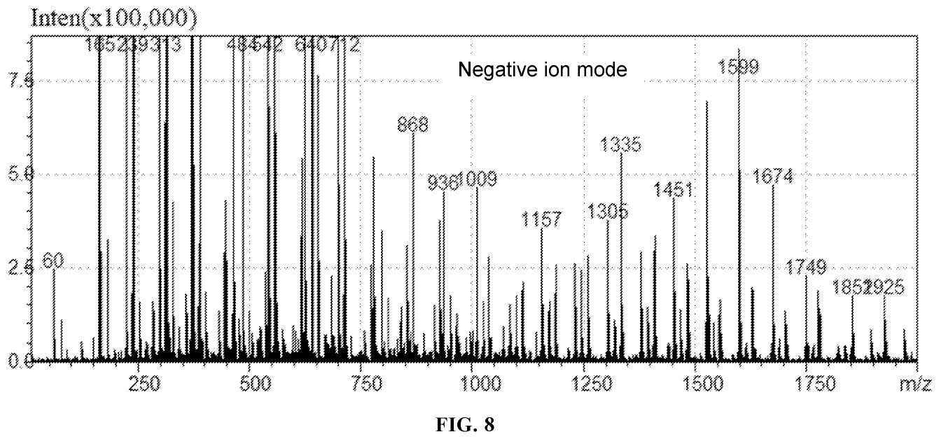

FIG. 7 shows a mass spectrogram of trimethylsiloxy-terminated polydimethylsiloxane having the average molecular weight of about 2000 in the positive ion mode. FIG. 8 shows a mass spectrogram of trimethylsiloxy terminated polydimethylsiloxane having the average molecular weight of about 2000 in the negative ion mode.

As shown in FIG. 7, in the positive ion mode, the evenly spaced mass spectrogram can be obtained by utilizing the fragment ions of trimethylsiloxy-terminated polydimethylsiloxane. The basic unit of trimethylsiloxy-terminated polydimethylsiloxane has the molecular weight of about 74. Therefore, the paired mass spectrum peaks with the mass-to-charge ratio spacing of about 74 in the mass spectrogram can be used for calibrating the mass spectrometer.

Similarly, as shown in FIG. 8, in the negative ion mode, the evenly spaced mass spectrogram can also be obtained by utilizing the fragment ions of trimethylsiloxy-terminated polydimethylsiloxane. The basic unit of trimethylsiloxy-terminated polydimethylsiloxane has the molecular weight of about 74. Therefore, the paired mass spectrum peaks with the mass-to-charge ratio spacing of about 74 in the mass spectrogram can be used for calibrating the mass spectrometer.

As can be seen from the mass spectrograms of FIGS. 7 and 8, the mass spectrograms generated by the trimethylsiloxy-terminated polydimethylsiloxane in both positive ion mode and negative ion mode can be used for calibrating the mass spectrometers. Therefore, the mass spectrometer can be calibrated in both positive ion mode and negative ion mode, respectively, by using a substance, trimethylsiloxy-terminated polydimethylsiloxane.

Perfluoropolyether (PFPE), which is marketed under the trade name Fomblin, is a synthetic polymer which is a liquid at room temperature. The perfluoropolyether is classified into 4 different molecular structures of K type, Y type, Z type and D type according to different monomers and polymerization methods used. The structural formula of the perfluoropolyether having the Y-type structure is as follows:

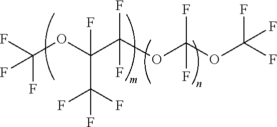

The perfluoropolyether is commonly used as a lubricant. The inventors of the invention have unexpectedly discovered that the perfluoropolyether is also suitable for use in calibrating the mass spectrometer.

In certain embodiments of the invention, the perfluoropolyether having the Y-type structure is used, which may have the average molecular weight of 1000 to 10000. For example, in one exemplary embodiment, the perfluoropolyether having the Y-type structure and the average molecular weight of 1800 is used. In another exemplary embodiment, the perfluoropolyether having the Y-type structure and the average molecular weight of 2500 is used.

In some embodiments of the invention, the ion source shown in FIG. 1 is used and the perfluoropolyether is used as the sample material for generating the fragment ions. The carrier gas is the nitrogen gas, the flow rate is controlled at about 0.5 L/min, the temperature of the first heater 4 is controlled between about 50° C. and about 200° C. (for example, about 100° C.), the temperature of the second heater 6 is controlled between about 100° C. and about 300° C. (for example, about 200° C.), and the voltage of the discharge needle 8 is about −4 kV. The temperature of the sampling interface 11 of the mass spectrometer 10 is about 250° C.

The specific operation steps are similar to those of the above dimethylsilicone oil, and will not be repeated herein.

Unlike the siloxane polymers, when the perfluoropolyether is used, only the mass spectrogram in the negative ion mode is suitable for calibrating the mass spectrometer.

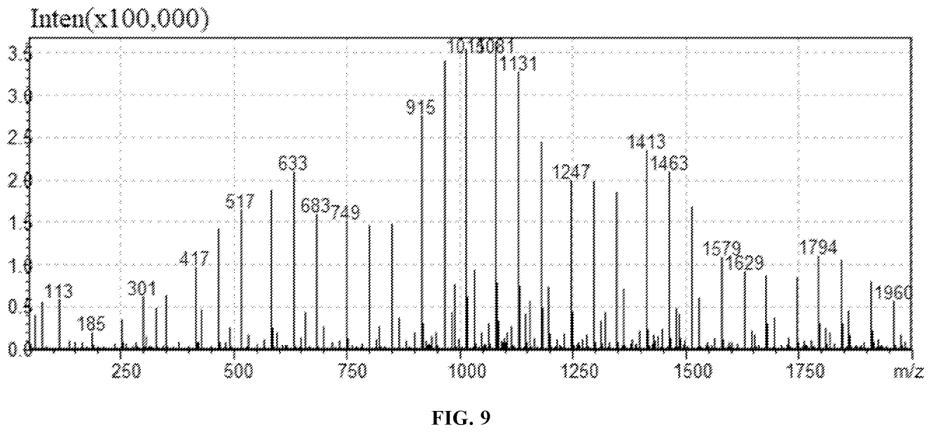

FIG. 9 shows a mass spectrogram of perfluoropolyether in the negative ion mode. As shown in FIG. 9, in the negative ion mode, the evenly spaced mass spectrogram can be obtained by utilizing the fragment ions of perfluoropolyether. One (—CF₂) fragment of perfluoropolyether has the molecular weight of about 50. Therefore, the mass spectrum peaks with the mass-to-charge ratio spacing of about 50 in the mass spectrogram can be used for calibrating the mass spectrometer.

Further, the perfluoropolyether having other structures can be used according to some embodiments of the invention. For example, the structural formula of the perfluoropolyether having the Z-type structure is as follows:

CF₃—[(OCF₂CF₂)ₚ—(OCF₂)_{q}]OCF₃

In some embodiments of the invention, the perfluoropolyether having the Z-type structure and the average molecular weight of about 2000 to about 30000 is used.

In other embodiments of the invention, the perfluoropolyether having the D-type or K-type structure can also be used, and the average molecular weight thereof can be from about 1000 to about 20000.

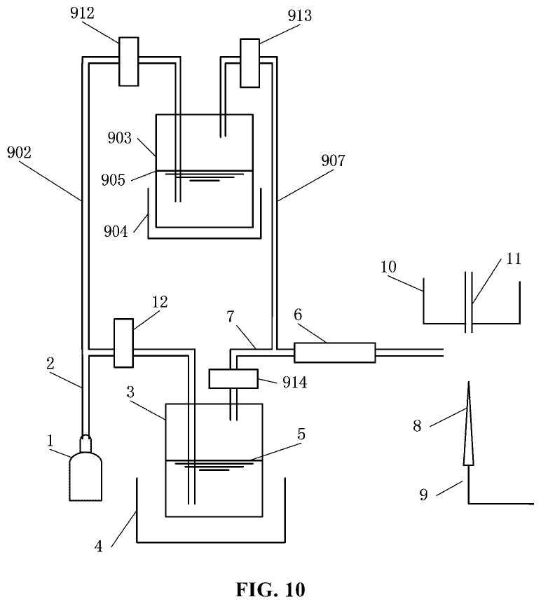

FIG. 10 shows a schematic diagram of the ion source for calibrating the mass spectrometer according to one embodiment of the invention.

As shown in FIG. 10, the ion source further comprises a third gas delivery pipe 902, a container 903, and a fourth gas delivery pipe 907 based on the ion source shown in FIG. 1. Wherein, the third gas delivery pipe 902 is in fluid communication with the first gas delivery pipe 2 to be used for delivering the carrier gas into the container 903. The container 903 contains the sample material therein, and the sample material can be different from the sample material in the container 3. For example, in one example, the sample material in the container 3 is the dimethylsilicone oil, and the sample material in the container 903 is the perfluoropolyether. The tail end of the third gas delivery pipe 902 can extend below a liquid level 905 as shown in FIG. 10. In one optional example, the tail end of the third gas delivery pipe 902 can be positioned above the liquid level 905. The fourth gas delivery pipe 907 is in fluid communication with the second gas delivery pipe 7 to be used for delivering the carrier gas in the container 903 and the vapor of the sample material to the vicinity of the discharge needle 8.

In addition, as shown in FIG. 10, a first valve 12 is arranged on the first gas delivery pipe 2, a second valve 912 can be arranged on the second gas delivery pipe 7, a third valve 914 is arranged on the third gas delivery pipe 902, and a fourth valve 913 is arranged on the fourth gas delivery pipe 907. The corresponding gas delivery pipes can be controlled by these valves to be turned on and off.

Other structures (for example, the discharge needle 8) of the ion source in FIG. 10 are similar to the ion source shown in FIG. 1, and will not be repeated herein.

By utilizing the ion source shown in FIG. 10, the mass spectrometer can be calibrated multiple times using different sample substances. In one embodiment according to the invention, the mass spectrometer can be calibrated twice using the perfluoropolyether and dimethylsilicone oil. For example, in the first calibration, the fragment ions may be generated by the dimethylsilicone oil in the positive ion mode and introduced into the mass spectrometer to obtain a first mass spectrogram, and the mass spectrometer is calibrated according to the first mass spectrogram. In the second calibration, the fragment ions may be generated by the perfluoropolyether in the negative ion mode and introduced into the mass spectrometer to obtain a second mass spectrogram, and the mass spectrometer is calibrated according to the second mass spectrogram. The specific steps for obtaining the mass spectrograms are similar to those described above in the invention, and will not be repeated herein.

Since the mass spectrogram obtained by the perfluoropolyether only in the negative ion mode is suitable for calibrating the mass spectrometer, in the embodiment, the mass spectrogram obtained by the dimethylsilicone oil in the positive ion mode is also used and the mass spectrometer is calibrated according to the mass spectrogram. By being calibrated in both positive ion mode and negative ion mode, the mass spectrometer can be used for measuring and analyzing positive ions and negative ions of a substance.

Further, although the mass spectrogram in the positive ion mode is firstly obtained, and then the mass spectrogram in the negative ion mode is obtained in the above description, it should be understood that any one of the mass spectrogram in the positive ion mode and the mass spectrogram in the negative ion mode can be firstly obtained, and can be selected by those skilled in the art according to actual needs under the teachings of the invention, and the invention is not limited thereto.

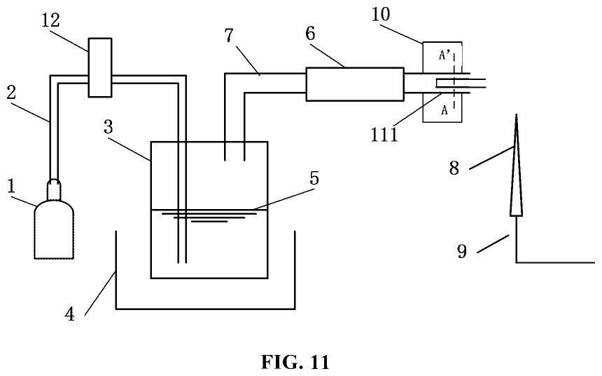

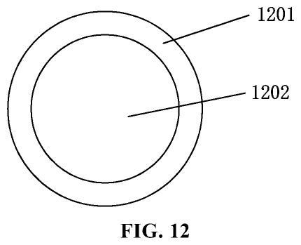

FIG. 11 shows a schematic diagram of the ion source for calibrating the mass spectrometer according to one embodiment of the invention. As shown in FIG. 11, the sampling interface 111 of the mass spectrometer 10 is a double-layered sleeve. FIG. 12 shows a cross-sectional view of a sampling interface 111 along a dotted line AA′. As shown in FIG. 12, the sampling interface 111 comprises two channels, namely, a first channel 1201 and a second channel 1202. Wherein, the second channel 1202 is positioned in the inner layer of the double-layered sleeve, and used for collecting sample ions and inputting the sample ions into the mass spectrometer. The first channel 1201 is positioned in the outer layer of the double-layered sleeve. The first channel 1201 can be used for delivering a dry gas. Further, the second gas delivery pipe 7 of the ion source can be in fluid communication with the first channel 1201 of the sampling interface 111. In this way, the sample substance can be delivered to the vicinity of the discharge needle 8 through the first channel 1201.

The methods for calibrating the mass spectrometers according to some embodiments of the invention are described in detail above in conjunction with the ion source shown in FIG. 1. However, it should be understood that the corona discharge is only a way of plasma discharge. In the embodiments of the invention, the ionization device may ionize the sample substance using other ways of plasma discharge, such as dielectric barrier discharge.

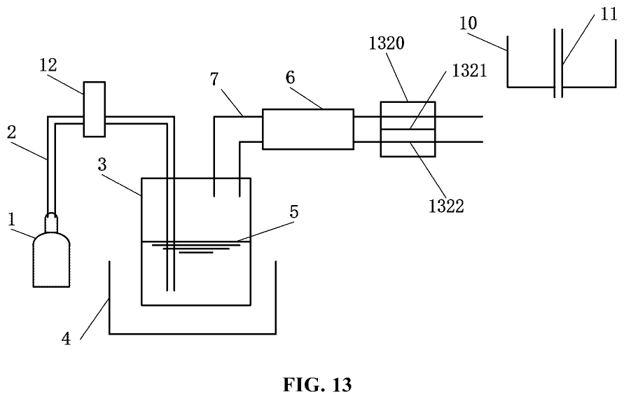

FIG. 13 shows a schematic diagram of the ion source for generating ions for calibrating the mass spectrometer according to one embodiment of the invention.

As shown in FIG. 13, a first electrode 1321 is arranged in a portion 1322 of the second gas delivery pipe 7. In some embodiments, the first electrode 1321 can be, for example, a linear electrode extending along the central axis of the second gas delivery pipe 7. A second electrode 1320 is arranged outside the portion 1322 of the second gas delivery pipe 7. In some embodiments of the invention, the second electrode 1320 can be a cylindrical electrode, and arranged to be coaxial with the first electrode 1321. The portion 1322 of the second gas delivery pipe 7 is composed of a dielectric medium, and the dielectric medium may be, for example, ceramic or Teflon. The first electrode 1321, the second electrode 1320, and the portion 1322 of the second gas delivery tube 7 collectively constitute the ionization device according to one embodiment of the invention.

When the voltage is applied to the first electrode 1321 and the second electrode 1320, the dielectric barrier discharge may be generated between the first electrode 1321 and the second electrode 1320. For example, an alternating current (AC) voltage having a frequency of 10 kHz to 10 MHz can be applied between the first electrode 1321 and the second electrode 1320, and the voltage can be, for example, about 1 kV to about 5 kV.

When the sample substance in the second gas delivery pipe 7 flows through, the dielectric barrier discharge between the first electrode 1321 and the second electrode 1320 can also ionize the sample substance to generate various ions and ion fragments.

The other portions of the plasma source shown in FIG. 13 are similar to the plasma source in FIG. 1, and the description will not be repeated in the invention.

Heretofore, the ion source for calibrating the mass spectrometer and the mass spectrometer according to the invention have been described in detail. In order to avoid obscuring the concepts of the invention, some details known in the art are not described. Those skilled in the art can fully understand how to implement the technical solutions disclosed herein according to the above description.

In addition, the invention may also comprise the following technical solutions.

1. An ion source for generating ions for calibrating a mass spectrometer comprises a container, used for containing a sample; an ionization device, used for ionizing the sample by plasma discharge to generate the ions for calibrating the mass spectrometer, where the ionization device operates at atmospheric pressure; and a delivery device, used for delivering the sample from the container to the ionization device.

2. The ion source according to the technical solution 1, the sample is a siloxane polymer or perfluoropolyether.

3. The ion source according to the technical solution 2, the siloxane polymer has the degree of polymerization of about 2 to about 100000.

4. The ion source according to the technical solution 3, the siloxane polymer has the degree of polymerization of about 2 to about 1000.

5. The ion source according to the technical solution 2, the siloxane polymer comprises polydimethylsiloxane, or poly(methyl-3,3,3-trifluoropropylsiloxane).

6. The ion source according to the technical solution 5, the polydimethylsiloxane is trimethylsiloxy-terminated polydimethylsiloxane.

7. The ion source according to the technical solution 5, the polydimethylsiloxane has an average molecular weight of about 500 to about 100000.

8. The ion source according to the technical solution 5, the poly(methyl-3,3,3-trifluoropropylsiloxane) has the average molecular weight of about 1000 to about 8000.

9. The ion source according to the technical solution 6, the trimethylsiloxy-terminated polydimethylsiloxane has the average molecular weight of about 800 to about 5000.

10. The ion source according to the technical solution 1, the ionization device comprises a discharge needle, and the discharge needle ionizes the sample by corona discharge.

11. The ion source according to the technical solution 1, the ionization device ionizes the sample by dielectric barrier discharge.

12. The ion source according to the technical solution 11, the ionization device comprises a first electrode, a second electrode, and a dielectric medium positioned between the first electrode and the second electrode.

13. The ion source according to the technical solution 2, the perfluoropolyether has the degree of polymerization of about 2 to about 3000.

14. The ion source according to the technical solution 2, the perfluoropolyether has the average molecular weight of about 1000 to about 30000.

15. The ion source according to the technical solution 14, the molecular structure of perfluoropolyether is a Y-type structure, and the perfluoropolyether has the average molecular weight of about 1000 to about 10000.

16. The ion source according to the technical solution 14, the molecular structure of perfluoropolyether is a Z-type structure, and the perfluoropolyether has the average molecular weight of about 2000 to about 30000.

17. The ion source according to the technical solution 14, the molecular structure of perfluoropolyether is a D-type or K-type structure, and the perfluoropolyether has the average molecular weight of about 1000 to about 20000.

18. The ion source according to the technical solution 1, the ions comprise positive ions and negative ions, and the negative ions generated from perfluoropolyether are used for calibrating the mass spectrometer.

19. The ion source according to the technical solution 10, the discharge needle has a voltage of about 3 kV to about 10 kV.

20. The ion source according to the technical solution 19, the discharge needle has the voltage of about 3.5 kV to about 4.5 kV.

21. The ion source according to the technical solution 1, further comprising a first heater, used for heating the container.

22. The ion source according to the technical solution 1, the delivery device comprises: a gas source, used for providing a carrier gas; a first gas delivery pipe, used for delivering the carrier gas into the container; and a second gas delivery pipe, used for delivering the carrier gas and the sample to the ionization device.

23. The ion source according to the technical solution 22, the delivery device further comprises a valve, arranged on the first gas delivery pipe or the second gas delivery pipe, and used for controlling the first gas delivery pipe or the second gas delivery pipe to be turned on and off.

24. The ion source according to technical solution 22, further comprising a second heater, used for heating the second gas delivery pipe.

25. The ion source according to the technical solution 21, the mass spectrometer comprises a sampling interface and a path for delivering a gas used for drying the sampling interface, and the second gas delivery pipe is fluidly connected to the path.

26. A mass spectrometer, comprising the ion source according to any one of the technical solutions 1 to 25.

27. A method of calibrating a mass spectrometer, comprising: generating ions by plasma discharge at atmospheric pressure using a sample; inputting at least one part of the ions into the mass spectrometer to obtain a mass spectrogram; and calibrating the mass spectrometer according to the mass spectrogram.

28. The method according to the technical solution 27, the sample is a siloxane polymer or perfluoropolyether.

29. The method according to the technical solution 27, the siloxane polymer has the degree of polymerization of about 1 to about 100000.

30. The method according to the technical solution 29, the siloxane polymer has the degree of polymerization of about 1 to about 1000.

31. The method according to the technical solution 27, the siloxane polymer comprises polydimethylsiloxane, or poly(methyl-3,3,3-trifluoropropylsiloxane).

32. The method according to the technical solution 31, the polydimethylsiloxane is trimethylsiloxy-terminated polydimethylsiloxane.

33. The method according to the technical solution 31, the polydimethylsiloxane has the average molecular weight of about 500 to about 100000.

34. The method according to the technical solution 31, the poly(methyl-3,3,3-trifluoropropylsiloxane) has the average molecular weight of about 1000 to about 8000.

35. The method according to the technical solution 32, the trimethylsiloxy-terminated polydimethylsiloxane has the average molecular weight of about 800 to about 5000.

36. The method according to the technical solution 27, the perfluoropolyether has the degree of polymerization of about 1 to about 3000.

37. The method according to the technical solution 36, the perfluoropolyether has the degree of polymerization of about 8 to about 45.

38. The method according to the technical solution 27, the plasma discharge is corona discharge or dielectric barrier discharge.

39. The method according to the technical solution 27, at least one part of positive ions in the ions are input to the mass spectrometer to obtain the mass spectrogram.

40. The method according to the technical solution 27, at least one part of negative ions in the ions are input to the mass spectrometer to obtain the mass spectrogram.

41. A method for calibrating a mass spectrometer, comprising: generating first ions by plasma discharge at atmospheric pressure using polydimethylsiloxane; inputting at least one part of positive ions in the first ions into the mass spectrometer to obtain a first mass spectrogram; calibrating the mass spectrometer according to the first mass spectrogram; generating second ions by plasma discharge at atmospheric pressure using perfluoropolyether; inputting at least one part of negative ions in the second ions into the mass spectrometer to obtain a second mass spectrogram; and calibrating the mass spectrometer according to the second mass spectrogram.

42. Uses of the silicone polymer as a calibration substance for the mass spectrometer.

43. The method according to the technical solution 42, the siloxane polymer has the degree of polymerization of about 1 to about 100000.

44. The method according to the technical solution 43, the siloxane polymer has the degree of polymerization of about 1 to about 1000.

45. The method according to the technical solution 42, the siloxane polymer comprises polydimethylsiloxane, or poly(methyl-3,3,3-trifluoropropylsiloxane).

46. The method according to the technical solution 45, the polydimethylsiloxane is trimethylsiloxy-terminated polydimethylsiloxane.

47. The method according to the technical solution 45, the polydimethylsiloxane has the average molecular weight of about 500 to about 100000.

48. The method according to the technical solution 45, the poly(methyl-3,3,3-trifluoropropylsiloxane) has the average molecular weight of about 1000 to about 8000.

49. The method according to the technical solution 46, the trimethylsiloxy-terminated polydimethylsiloxane has the average molecular weight of about 800 to about 5000.

50. The method according to any one of the technical solutions 42 to 49, the siloxane polymer generates the ions for calibrating the mass spectrometer by plasma discharge at atmospheric pressure.

51. The method according to the technical solution 50, the plasma discharge is corona discharge or dielectric barrier discharge.

The foregoing descriptions are merely preferred embodiments of the present invention, but are not intended to limit the invention. For a person skilled in the art, the present invention can have various modifications and changes. Any modification, equivalent replacement, or improvement made within the spirit and principle of the invention shall fall within the protection scope of the present invention.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the invention pertains without departing from its spirit and scope. Accordingly, the scope of the invention is defined by the appended claims rather than the foregoing description and the exemplary embodiments described therein.

What is claimed is:

1. An ion source for generating ions for calibrating a mass spectrometer, comprising:
a container, used for containing a sample;
an ionization device, used for ionizing the sample by plasma discharge to generate the ions for calibrating the mass spectrometer, wherein the ionization device operates at atmospheric pressure; and
a delivery device, used for delivering the sample from the container to the ionization device.

2. The ion source of claim 1, wherein the sample is a siloxane polymer or perfluoropolyether.

3. The ion source of claim 2, wherein the siloxane polymer has a degree of polymerization of about 2 to about 100000.

4. The ion source of claim 3, wherein the siloxane polymer has the degree of polymerization of about 2 to about 1000.

5. The ion source of claim 2, wherein the siloxane polymer comprises polydimethylsiloxane, or poly(methyl-3,3,3-trifluoropropylsiloxane).

6. The ion source of claim 5, wherein the polydimethylsiloxane is trimethylsiloxy-terminated polydimethylsiloxane.

7. The ion source of claim 5, wherein the polydimethylsiloxane has an average molecular weight of about 500 to about 100000.

8. The ion source of claim 5, wherein the poly(methyl-3,3,3-trifluoropropylsiloxane) has the average molecular weight of about 1000 to about 8000.

9. The ion source of claim 6, wherein the trimethylsiloxy-terminated polydimethylsiloxane has the average molecular weight of about 800 to about 5000.

10. The ion source of claim 1, wherein the ionization device comprises a discharge needle, and the discharge needle ionizes the sample by corona discharge.

11. The ion source of claim 1, wherein the ionization device ionizes the sample by dielectric barrier discharge.

12. The ion source of claim 11, wherein the ionization device comprises a first electrode, a second electrode, and a dielectric medium positioned between the first electrode and the second electrode.

13. The ion source of claim 2, wherein the perfluoropolyether has a degree of polymerization of about 2 to about 3000.

14. The ion source of claim 2, wherein the perfluoropolyether has the average molecular weight of about 1000 to about 30000.

15. The ion source of claim 14, wherein the molecular structure of perfluoropolyether is a Y-type structure, and the perfluoropolyether has the average molecular weight of about 1000 to about 10000.

16. The ion source of claim 14, wherein the molecular structure of perfluoropolyether is a Z-type structure, and the perfluoropolyether has the average molecular weight of about 2000 to about 30000.

17. The ion source of claim 14, wherein the molecular structure of perfluoropolyether is a D-type or K-type structure, and the perfluoropolyether has the average molecular weight of about 1000 to about 20000.

18. The ion source of claim 1, wherein the ions comprise positive ions and negative ions, and the negative ions generated from the perfluoropolyether are used for calibrating the mass spectrometer.

19. The ion source of claim 10, wherein the discharge needle has a voltage of about 3 kV to about 10 kV.

20. The ion source of claim 19, wherein the discharge needle has the voltage of about 3.5 kV to about 4.5 kV.

21. The ion source of claim 1, further comprising a first heater, used for heating the container.

22. The ion source of claim 1, wherein the delivery device comprises:
a gas source, used for providing a carrier gas;
a first gas delivery pipe, used for delivering the carrier gas into the container; and
a second gas delivery pipe, used for delivering the carrier gas and the sample to the ionization device.

23. The ion source of claim 22, wherein the delivery device further comprises a valve, arranged on the first gas delivery pipe or the second gas delivery pipe, and used for controlling the first gas delivery pipe or the second gas delivery pipe to be turned on and off.

24. The ion source of claim 22, further comprising a second heater, used for heating the second gas delivery pipe.

25. The ion source of claim 21, wherein the mass spectrometer comprises a sampling interface and a path for delivering a gas used for drying the sampling interface, and the second gas delivery pipe is fluidly connected to the path.

26. A mass spectrometer, comprising the ion source of claim 1.

27. A method of calibrating a mass spectrometer, comprising:
generating ions by plasma discharge at atmospheric pressure using a sample;
inputting at least one part of the ions into the mass spectrometer to obtain a mass spectrogram; and
calibrating the mass spectrometer according to the mass spectrogram.

28. The method of claim 27, wherein the sample is a siloxane polymer or perfluoropolyether.

29. The method of claim 27, wherein the siloxane polymer has a degree of polymerization of about 1 to about 100000.

30. The method of claim 29, wherein the siloxane polymer has the degree of polymerization of about 1 to about 1000.

31. The method of claim 27, wherein the siloxane polymer comprises polydimethylsiloxane, or poly(methyl-3,3,3-trifluoropropylsiloxane).

32. The method of claim 31, wherein the polydimethylsiloxane is trimethylsiloxy-terminated polydimethylsiloxane.

33. The method of claim 31, wherein the polydimethylsiloxane has an average molecular weight of about 500 to about 100000.

34. The method of claim 31, wherein the poly(methyl-3,3,3-trifluoropropylsiloxane) has an average molecular weight of about 1000 to about 8000.

35. The method of claim 32, wherein the trimethylsiloxy-terminated polydimethylsiloxane has the average molecular weight of about 800 to about 5000.

36. The method of claim 27, wherein the perfluoropolyether has a degree of polymerization of about 1 to about 3000.

37. The method of claim 36, wherein the perfluoropolyether has the degree of polymerization of about 8 to about 45.

38. The method of claim 27, wherein the plasma discharge is corona discharge or dielectric barrier discharge.

39. The method of claim 27, wherein at least one part of positive ions in the ions are input to the mass spectrometer to obtain the mass spectrogram.

40. The method of claim 27, wherein at least one part of negative ions in the ions are input to the mass spectrometer to obtain the mass spectrogram.

41. A method for calibrating a mass spectrometer, comprising:
generating first ions by plasma discharge at atmospheric pressure using polydimethylsiloxane;
inputting at least one part of positive ions in the first ions into the mass spectrometer to obtain a first mass spectrogram;
calibrating the mass spectrometer according to the first mass spectrogram;
generating second ions by plasma discharge at atmospheric pressure using perfluoropolyether;
inputting at least one part of negative ions in the second ions into the mass spectrometer to obtain a second mass spectrogram; and
calibrating the mass spectrometer according to the second mass spectrogram.

42. Uses of a silicone polymer as a calibration substance for a mass spectrometer.

43. The method of claim 42, wherein the siloxane polymer has a degree of polymerization of about 1 to about 100000.

44. The method of claim 43, wherein the siloxane polymer has the degree of polymerization of about 1 to about 1000.

45. The method of claim 42, wherein the siloxane polymer comprises polydimethylsiloxane, or poly(methyl-3,3,3-trifluoropropylsiloxane).

46. The method of claim 45, wherein the polydimethylsiloxane is trimethylsiloxy-terminated polydimethylsiloxane.

47. The method of claim 45, wherein the polydimethylsiloxane has an average molecular weight of about 500 to about 100000.

48. The method of claim 45, wherein the poly(methyl-3,3,3-trifluoropropylsiloxane) has an average molecular weight of about 1000 to about 8000.

49. The method of claim 46, wherein the trimethylsiloxy-terminated polydimethylsiloxane has the average molecular weight of about 800 to about 5000.

50. The method of claim 42, wherein the siloxane polymer generates the ions for calibrating the mass spectrometer by plasma discharge at atmospheric pressure.

51. The method of claim 50, wherein the plasma discharge is corona discharge or dielectric barrier discharge.
